(19) United States
(12) Patent Application Publication
(10) Pub. No.: US 2026/0124929 A1
(43) Pub. Date: May 7, 2026

(54) ROTOR LOCK PREVENTION SYSTEMS FOR ELECTRIC VEHICLES AND RELATED METHODS

(71) Applicant: Ford Global Technologies, LLC, Dearborn, MI (US)

(72) Inventors: Nicholas Church, Allen Park, MI (US); Jonathan Hair, Northville, MI (US); Keith Weston, Canton, MI (US); Matthew David Penne, Pierce, NE (US); Brendan Francis Diamond, Naples, FL (US)

(21) Appl. No.: 18/939,224

(22) Filed: Nov. 6, 2024

(51) Int. Cl. B60L 15/20; B60L 3/00

(52) U.S. Cl. CPC B60L 15/2054; B60L 3/0061; B60L 2240/12; B60L 2240/421; B60L 2240/507

(57) ABSTRACT

Rotor lock prevention systems and related methods are disclosed. An example apparatus includes an electric motor having an output shaft, a drive shaft to drive one or more wheels of a vehicle, a fluid torque converter to operatively couple the output shaft of the electric motor and the drive shaft, and a clutch movable between an open position and a closed position. The clutch is to fluidly couple the output shaft of the electric motor and the drive shaft when the clutch is in the open position. The clutch to enable the electric motor to bypass the fluid torque converter to mechanically couple the output shaft of the electric motor and the drive shaft when the clutch is in the closed position.

### FIELD OF THE DISCLOSURE

This disclosure relates generally to vehicles and, more particularly, to rotor lock prevention systems and related methods.

### BACKGROUND

Electric vehicles (EVs) employ electric motors or electric machines to apply torque to rotate wheels of the electric vehicles. However, electric vehicles can be limited in applications (e.g., off-road applications, towing applications, etc.) due to rotor lock torque (LRT) characteristics of electric motors.

### BRIEF DESCRIPTION OF THE DRAWINGS

FIG. 1 is a perspective view of an example vehicle in which examples disclosed herein can be implemented.

FIG. 2 is a schematic illustration of the example vehicle of FIG. 1 having an example rotor locking prevention system in accordance with teachings of this disclosure.

FIG. 3A is a side, partial cutaway view of an example fluid coupling of FIG. 2 with an example lock-out clutch in an example open position.

FIG. 3B is a side, partial cutaway view of the example fluid coupling of FIG. 3A with the example lock-out clutch in an example open position.

FIG. 4 is a block diagram of an example implementation of an example rotor lock prevention control circuitry of FIG. 2.

FIGS. 5-8 are flowcharts representative of example machine readable instructions and/or example operations that may be executed, instantiated, and/or performed by example programmable circuitry to implement the example rotor lock prevention control circuitry of FIG. 4.

FIG. 9 is a block diagram of an example processing platform including programmable circuitry structured to execute, instantiate, and/or perform the example machine readable instructions and/or perform the example operations of FIGS. 5-8 to implement the example rotor lock prevention control circuitry of FIG. 4.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Rotor lock torque, also known as starting torque, is a torque (e.g., a maximum torque) that an electric motor produces when a rotor of the motor is stationary and full power or torque demand is commanded. For example, rotor lock torque is an initial torque generated by a motor when the motor or vehicle starts rotating from a standstill or initial position. Thus, an electric vehicle starting from a standstill position can produce a maximum torque corresponding to the rotor lock torque characteristic of the electric motor. To this end, electric vehicles can be limited in certain applications where a motor needs to start under load that exceeds the rotor lock torque.

As a result of rotor lock torque limitations, electric vehicles employing electric motors can experience reduced motor performance at low speeds and/or when starting from a standstill position (e.g., a vehicle speed of zero). At low or zero vehicle speeds, an electric motor may not generate enough torque to overcome a load or obstacle if a voltage supplied to the motor is insufficient. In some examples, when the vehicle speed is zero, reduced motor performance can occur when the vehicle is attempting to overcome an obstacle in the vehicle's path, is towing weight, the vehicle is traveling or is at a standstill on an inclined road or graded path (e.g., a grade of greater than 20 degrees).

When an electric motor stalls, the motor typically continues to draw maximum current. In some instances, at motor stall, a motor does not generate back electromotive force (EMF), resulting in maximum power consumption, which can reduce battery range of the electric vehicle. Thus, electric vehicles may experience reduced performance for off-road applications, towing applications, traveling on a grade (e.g., an incline of approximately 20 degrees or greater), and/or traversing other obstacles in the vehicle's path.

Some electric vehicle manufacturers upsize an inverter (e.g., a power capacity of an inverter) of the electric vehicle to reduce stall issues due to rotor lock torque. However, upsizing a power capacity of an inverter leads to increased complexity associated with integrating and/or modifying an electrical system of the electrical vehicle to manage the upsized power capacity of the inverter. Thus, employing larger inverters can require more space and add weight to the vehicle, which could affect (e.g., degrade or decrease) overall performance and efficiency of the vehicle (e.g., a single charge range of the vehicle). In some instances, a larger sized motor having greater rotor lock torque characteristics can be employed. However, such an approach significantly increases weight and/or consumes a greater amount of power, reducing an overall mileage/battery charge cycle of the vehicle.

Examples disclosed herein enhance drivability by reducing or preventing instances of rotor lock and/or motor stall in electric vehicles. To reduce or prevent rotor lock conditions, example electric vehicles disclosed herein employ a rotor lock prevention system that detects rotor lock conditions of a vehicle. When activated, example rotor lock prevention systems disclosed herein maintain a minimum motor speed of an electric motor (e.g., 500 revolutions per minute (RPM) minimum) that allows or corresponds to a full torque capability of the electric motor. Example rotor lock prevention systems disclosed herein can use closed loop speed control to maintain motor speed at speeds equal to or greater than a minimum motor speed threshold (e.g., at or greater than 500 revolutions per minute (rpm)). When a rotor lock condition is not detected, the example rotor lock prevention systems disclosed herein are deactivated, reducing inefficiencies associated with the example rotor lock prevention systems.

Example rotor lock prevention systems disclosed herein employ transmission systems including a fluid coupling (e.g., a torque converter) and a lock-out clutch. Specifically, example fluid couplings disclosed herein enable slip between an output shaft of a motor and an input or drive shaft of a transmission, enabling the motor to operate at a minimum speed when the vehicle is standstill (i.e., a vehicle speed is zero).

Additionally, examples disclosed herein employ a lock-out clutch to activate or enable the fluid coupling between output shaft of the motor and the input shaft of the transmission when slip is needed (e.g., a vehicle speed does not exceed a vehicle speed threshold) and disable or bypass the fluid coupling between the output shaft of the motor and the input shaft of the transmission when slip is not needed (e.g., a vehicle speed exceeds a vehicle speed threshold). To operate the lock-out clutch and/or activate or determine a rotor lock condition of a vehicle, example transmission systems disclosed herein employ a rotor lock prevention control system (e.g., processor circuitry).

Example fluid couplings disclosed herein reduce instances of motor stall at low vehicle speeds because the fluid coupling allows slip to enable the electric motor to operate at elevated or threshold motor speeds when the vehicle is at a standstill (e.g., vehicle speed is zero). Additionally, the example fluid coupling (e.g., torque converters) disclosed herein provides torque multiplication that can enhance vehicle performance. In some instances, example fluid couplings (e.g., torque converter) disclosed herein can improve vehicle drivability by damping torque ripple (e.g., periodic variation in the torque output) from the electric motor (e.g., during rock climbing at low speed). With example fluid coupling or torque converters disclosed herein, an electric motor can be employed with less consideration for torque ripple. For example, the electric motor can have less rotor skew. Reducing rotor skew improves torque and/or power density, which reduces mechanical vibrations and/or noise, thereby improving motor performance.

In some examples, torque multiplication provided by example torque converters disclosed herein at low vehicle speeds can allow a gearbox ratio to be taller, thereby increasing or improving top speed performance of the electric vehicle. In some examples, torque multiplication provided by the example fluid couplings and/or torque converters disclosed herein allow downsizing of a motor, which reduces weight. In some examples, at low vehicle speeds, torque multiplication provided by the fluid coupling can allow an electric motor to operate at lower torques and lower current, reducing motor power losses (e.g., I²R losses). Additionally, example lock-out clutches can lock out or bypass the fluid coupling or torque converter to negate losses and any inefficiency at greater vehicle speeds.

Example rotor lock prevention systems disclosed herein can be activated manually (e.g., via a human machine interface or user input) or automatically based on a detected vehicle condition. For example, example rotor lock prevention systems disclosed herein can activate upon detection of a vehicle in a towing mode, an off-road mode, a hill hold mode, motor speed/torque ratio irregularity, inverter phase current irregularity, and/or any other condition(s).

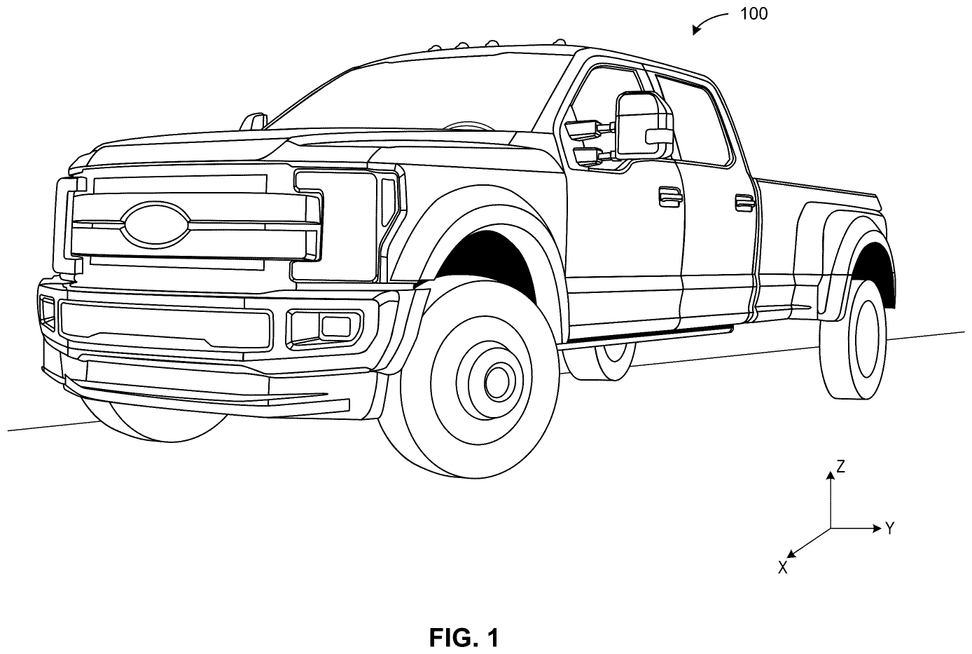

FIG. 1 illustrates an example electric vehicle (EV) 100 in which the teachings of this disclosure can be implemented. In the illustrated example of FIG. 1, the electric vehicle 100 is a pick-up truck. In other examples, the electric vehicle 100 can be any type of electric vehicle (e.g., a van, a coupe, a sedan, a sport utility vehicle (SUV), a semi-trailer truck, a mini-van, a railed vehicle, an all-terrain vehicle (ATV), etc.). In the illustrated example of FIG. 1, the electric vehicle 100 is a two-axle vehicle. Examples disclosed herein are suitable for driven axles (e.g., front axles and/or rear axles).

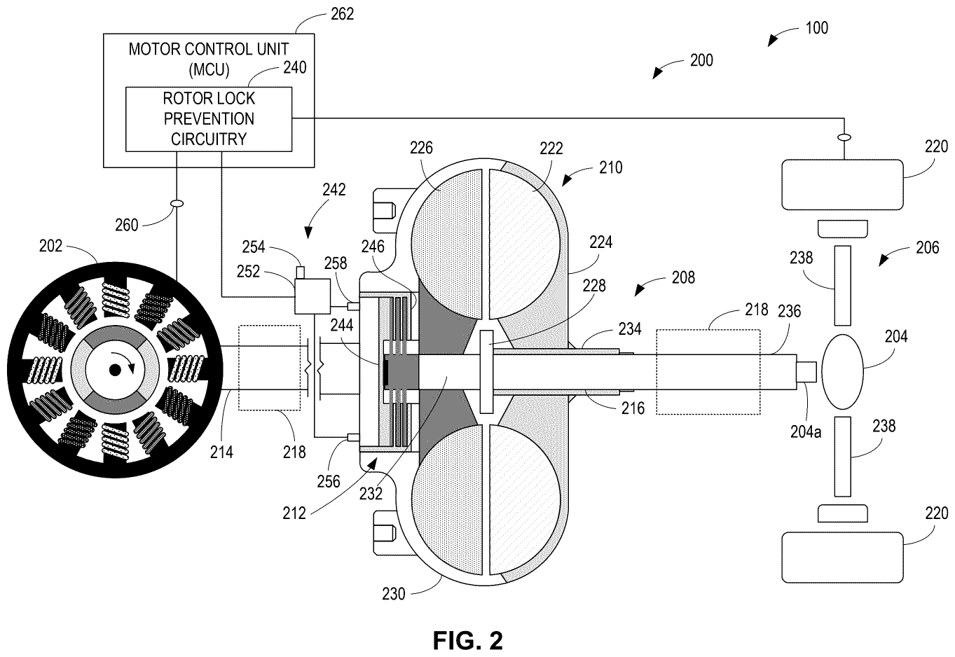

FIG. 2 is a schematic diagram of an example rotor lock prevention system 200 of the electric vehicle 100 of FIG. 1 in accordance with the teachings of this disclosure. The example rotor lock prevention system 200 of the illustrated example includes an electric motor 202 (e.g., an electric machine) coupled to a differential 204 (e.g., a rear axle or differential) of a drive axle 206 (e.g., a rear axle, a front axle, etc.) via a transmission 208. The electric motor 202 of the illustrated example can be an alternating current (AC) motor (e.g., a three-phase motor), a brushless direct current (BLDC) motor, and/or any other electric motor(s) and/or electric machine(s).

The rotor lock prevention system 200 of the illustrated example includes a fluid coupling 210 (e.g., a fluid torque converter) and a clutch 212 (e.g., a lock-up clutch). Specifically, the electric motor 202 has an output shaft 214 that is operatively coupled to a drive shaft 216 (e.g., an input shaft) of the transmission 208. The drive shaft 216 provides an input (e.g., input torque and/or speed) to the differential 204. In some examples, the rotor lock prevention system 200 and/or the transmission 208 of the electric vehicle 100 can include a gearbox 218. In some examples, the gearbox 218 can be coupled between the output shaft 214 of the electric motor 202 and the fluid coupling 210. In some examples, the gearbox 218 can be coupled between the fluid coupling 210 and the differential 204. In some examples, the transmission 208 of the illustrated example can include a plurality of gearboxes (e.g., two or more).

The fluid coupling 210 of the illustrated example is a torque converter (e.g., a hydraulic torque converter). For example, the fluid coupling 210 of the illustrated example can be a lock-up torque converter, a multi-passage torque converter (e.g., a two-passage torque converter, a three-passage torque converter, a four-passage torque converter), a high-stall torque converter, and/or any other type of torque converter and/or fluid coupling.

The fluid coupling 210 includes a drive rotor or impeller 222 coupled to a housing 224, a driven rotor or turbine 226, a stator 228 and the clutch 212 (e.g., a lock-out clutch). A front cover 230 is coupled (e.g., fixed, welded, etc.) to the housing 224 to enclose the clutch 212, the impeller 222 and the turbine 226. The front cover 230 and the housing 224 receives or encloses a fluid (e.g., transmission fluid, hydraulic fluid, oil, etc.). The output shaft 214 of the electric motor 202 of the illustrated example is coupled (e.g., fixed) to the front cover 230, which is coupled (e.g., rotatably fixed) to the impeller 222 via the housing 224 (e.g., the front cover 230 is fixed, welded, or fastened to the housing 224). For example, the output shaft 214 of the electric motor 202 can include a plate (e.g., welded or fixed to an end of the output shaft 214) that couples or attaches to the front cover 230 (e.g., via fasteners, weld, etc.). The drive shaft 216 of the illustrated example is coupled to the turbine 226. Specifically, a first end 232 of the drive shaft 216 extends within the housing 224 of the fluid coupling 210 and couples to the turbine 226 (e.g., via a spline connection). Thus, rotation of the output shaft 214 causes rotation of the impeller 222, which causes the fluid within the fluid coupling 210 to rotate the turbine 226 and, thus, rotate the drive shaft 216. The housing 224 of the illustrated example includes a drive hub 234 (e.g., a bushing) to enable the first end 232 of the drive shaft 216 to pass through the housing 224 and/or to enable rotation of the housing 224 and/or the impeller 222 relative to the drive shaft 216. A second end 236 of the drive shaft 216 opposite the first end 232 is coupled (e.g., via a gear such as a bevel gear) to the differential 204 (e.g., an input) of the drive axle 206. The differential 204 includes half-shafts 238 extending from the differential 204 to respective ones of wheels 220 (e.g., rear wheels of the electric vehicle 100). In some examples, the drive shaft 216 can be coupled to an input shaft 204a of the differential 204.

During operation of the electric vehicle 100, an output torque requirement of the electric motor 202 that exceeds a rotor lock torque (e.g., a maximum torque output) characteristic of the electric motor 202 can cause motor stall when the electric vehicle 100 is starting from a standstill position (e.g., vehicle speed is zero).

For example, in scenarios where the electric vehicle 100 is in a towing mode (e.g., towing a load), an off-road mode, traversing and/or stopped on an inclined grade, and/or otherwise overcoming an obstacle when the electric vehicle 100 is starting from a standstill position, a torque requirement to overcome the obstacle can be as much as 3.5 times a torque output of the output shaft and/or the electric motor 202. Such torque requirement may be greater than the rotor lock torque (e.g., a maximum output torque) of the electric motor 202 associated with a zero vehicle speed.

To overcome rotor lock torque limitations of the electric motor 202, the electric vehicle 100 of the illustrated example employs the fluid coupling 210. The fluid coupling 210 enables slip between the output shaft 214 and the drive shaft 216. As a result, the electric motor 202 can be commanded to rotate at a minimum motor speed threshold when the electric vehicle 100 is at a standstill position or traveling at low speeds (e.g., less than 5 mph, 10 mph, etc.). For example, the electric motor 202 can operate at a minimum motor speed threshold (e.g., 500 rpm) that enables a maximum torque output of the electric motor 202, thereby eliminating or reducing rotor lock torque. The fluid coupling provided by the fluid coupling 210 between the output shaft 214 and the drive shaft 216 enables the output shaft 214 to rotate (e.g., slip) while the drive shaft 216 is in a stall or zero rotational velocity condition. As a result, the fluid coupling 210 enables the output shaft 214 of the electric motor 202 to rotate at a first speed different than a second speed of the drive shaft 216.

To enable slip, the fluid coupling 210 fluidly couples (e.g., mechanically decouples) the output shaft 214 and the drive shaft 216. In operation, rotation of the output shaft 214 of the electric motor 202 causes the impeller 222 to rotate via the front cover 230 and housing 224 connection. When the electric motor 202 rotates, it spins or rotates the impeller 222, which in turn sets fluid in the housing 224 in motion (e.g., centrifugal motion). Specifically, centrifugal force moves the fluid toward an outer wall of the housing 224. The fluid then moves through blades of the stator 228 positioned between the impeller 222 and the turbine 226. The stator 228 deflects the fluid flow, thereby increasing a torque delivered to a force output side and/or toward the turbine 226. As the fluid moves from the impeller 222 to the turbine 226 via the stator 228, the fluid generates torque on the turbine 226, causing the turbine 226 and, thus, the drive shaft 216, to rotate thereby providing an input force to the differential 204 which causes rotation of the wheels 220.

The torque multiplication effect allows the fluid coupling 210 to increase a torque output from the electric motor 202 enabling enhanced vehicle acceleration and overall performance. This is particularly useful during acceleration and when overcoming resistance, such as when starting from a stop, towing operations, or climbing a hill. Additionally, the fluid coupling 210 enables smooth engagement or transition of power from the electric motor 202 to the transmission 208 or the drive shaft 216. Additionally, torque amplification provided by the fluid coupling 210 reduces loads and/or strain on the electric motor 202, which results in less wear of the electric motor 202 and thereby extending a lifespan of the electric motor 202.

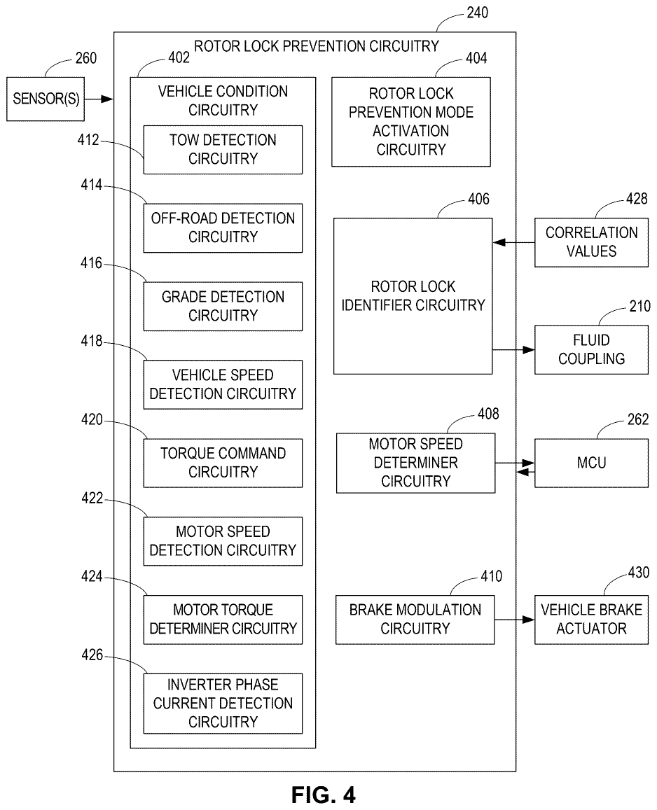

Additionally, the rotor lock prevention system 200 of the illustrated example employs rotor lock prevention circuitry 240 to bypass the fluid coupling 210 or employ the fluid coupling 210 based on a condition of the electric vehicle 100 as described in greater detail below in connection with FIGS. 4-8. Specifically, bypassing the fluid coupling 210 enables the output shaft 214 to be mechanically coupled (e.g., rigidly fixed) to the drive shaft 216 to prevent slip between the output shaft 214 and the drive shaft 216. Enabling or activating the fluid coupling 210 fluidly couples (e.g., mechanically decouples) the output shaft 214 and the drive shaft 216 to allow slip between the output shaft 214 and the drive shaft 216.

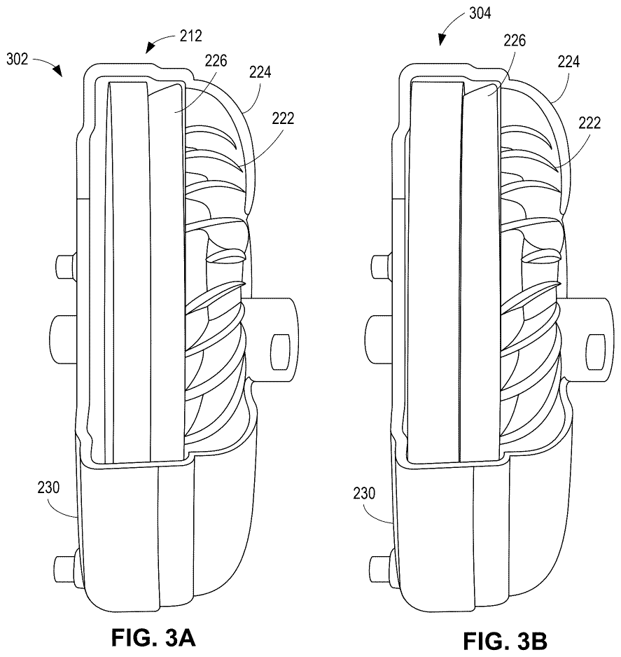

To engage and/or disengage the fluid coupling 210, the rotor lock prevention system of the illustrated example includes the clutch 212 (e.g., a lock-up clutch). The clutch 212 of the illustrated example is movable between a disengaged position (e.g., a disengaged position 302 of FIG. 3A) and an engaged position (e.g., an engaged position 304 of FIG. 3B). In the disengaged position 302, the clutch 212 mechanically decouples the impeller 222 and the turbine 226. Thus, the output shaft 214 of the electric motor 202 and the drive shaft 216 are fluidly coupled via the fluid coupling 210 (e.g., resulting in torque generation and/or torque amplification as described above) when the clutch is in the disengaged position 302, thereby enabling slip between the output shaft 214 of the electric motor 202 and the drive shaft 216. In this manner, the output shaft 214 of the electric motor 202 rotates at a first speed different than a second speed of the drive shaft 216. In the engaged position 304, the clutch 212 directly or rigidly connects (e.g., mechanically couples) the impeller 222 and turbine 226, effectively bypassing the fluid coupling 210. In this manner, the clutch 212 prevents slip between the output shaft 214 of the electric motor 202 and the drive shaft 216 when the clutch 212 is in the engaged position. As a result, the output shaft 214 and the drive shaft 216 rotate at the same speed. In some examples, the clutch 212 is moved to the engaged position 304 at higher vehicle speeds, thereby improving efficiency and reducing heat generation. Specifically, bypassing the fluid coupling 210 reduces power loss and/or heat generation caused by the fluid connection between the impeller 222 and the turbine 226.

The clutch 212 of the illustrated example is an electronically operated clutch. To control or move the clutch 212 between the disengaged position and the engaged position, the rotor lock prevention system 200 employs a pressurized fluid system 242. The pressurized fluid system 242 provides or supplies pressurized fluid either to a front surface 244 of the clutch 212 or a rear surface 246 of the clutch 212 opposite the front surface 244. The engagement and disengagement of the clutch 212 depends on a direction of pressurized fluid relative to the clutch 212.

To control the pressurized fluid of the clutch 212, the example pressurized fluid system 242 of the illustrated example includes a main regulator valve 252 that is piloted by a solenoid 254. For example, commanding the solenoid 254 to a first position (e.g., an “on” position) causes the valve 250 to provide pressurized fluid to the front surface 244 of the clutch 212 (e.g., a clutch disk, a plurality of clutch disks) via a first port 256 of the front cover 230. For example, the solenoid 254 can be energized via a command signal (e.g., a current, an electrical signal, a binary value “1”, etc.) to cause the solenoid 254 to move to the first position. In turn, the pressurized fluid imparts a force to the front surface 244 of the clutch 212 (e.g., the clutch disk) to cause the clutch 212 to move (e.g., axially slide) to the disengaged position 302 (e.g., e.g., to cause the clutch 212 to move in a direction away from the front cover 230 to frictionally disengage the front cover 230). In this state, the clutch 212 is in the disengaged position 302 (e.g., an open position), which mechanically decouples from the front cover 230. Thus, when the clutch 212 is the disengaged position 302, the clutch 212 causes the output shaft 214 and the drive shaft 216 to be fluidly coupled (e.g., mechanically decoupled) via the fluid coupling 210.

In contrast, commanding the solenoid 254 to a second position (e.g., an “off” position) causes the valve 250 to direct pressurized fluid to the rear surface 246 of the clutch 212 via a second port 258 of the front cover 230. For example, the solenoid 254 can be switched off via a command signal (e.g., removing a current, a binary value “0,” etc.) to cause the solenoid 254 to move to the second position. In turn, the increased pressure causes the clutch 212 to move (e.g., axially slide) toward the front cover 230 to engage (e.g., frictionally engage) with the front cover 230. The clutch 212, being coupled to the turbine 226, causes the turbine 226 to rotate with the front cover 230, the housing 224 and the impeller 222 when the clutch 212 is in the engaged position 304 (e.g., the clutch 212 is in frictional engagement with the front cover 230). In the engaged position 304, the clutch 212 mechanically couples the output shaft 214 and the drive shaft 216. When the clutch 212 is in the engaged position 304, the impeller 222 is mechanically coupled to the turbine 226 and power from the electric motor 202 is transferred to the transmission 208 without power losses caused by the fluid coupling 210. Additionally, the clutch 212 of the illustrated example includes dampening springs that absorb torsional vibrations during clutch engagement/disengagement to prevent or reduce shock transfer to the transmission 208.

To determine rotor lock conditions and/or control a state of the clutch 212, the example rotor lock prevention system of the illustrated example include the rotor lock prevention circuitry 240. In general, the rotor lock prevention circuitry 240 controls a state of the clutch 212 based on a detected condition of the electric vehicle 100. For example, the rotor lock prevention circuitry 240 causes the clutch 212 to open/disengage when rotor lock conditions are detected at low vehicle speeds to maintain the transmission 208 in a slip state. In contrast, the rotor lock prevention circuitry 240 causes the clutch 212 to close/engage when rotor lock conditions are not present and/or vehicle is operating above threshold vehicle speed to maintain the transmission 208 in a non-slip state.

In some examples, to determine rotor lock conditions, the rotor lock prevention circuitry 240 compares one or more of motor speed values, torque command values, motor torque output values, inverter phase current values and/or other parameter(s) of the electric vehicle 100 indicative of an irregularity and/or exceeding desired operating parameters. For example, the rotor lock prevention circuitry 240 employs one or more signals (e.g., feedback signals) from the one or more sensor(s) 260 and/or a motor control unit (MCU) 262 of the electric vehicle 100. For example, the MCU 262 is an electronic module that interfaces between one or more batteries (e.g., DC power source) and the electric motor 202 (e.g., AC motor). In the illustrated example, the MCU 262 converts direct current supplied from the batteries of the electric vehicle 100 into a three-phase AC current that drives the electric motor 202. Thus, the MCU 262 controls the motor speed and/or the torque of the electric motor 202. The one or more sensor(s) 260 can include a tachometer(s), a magnetic sensor(w) (e.g., a hall effect sensor(s)), inductive sensor(s), a temperature sensor(s), current sensor(s), an encoder(s), a resolver(s), a camera(s), an imaging sensor(s), an accelerometer(s), a trailer light detection sensor(s) and/or any other sensor(s). For example, hall effect sensors, encoders, resolvers, etc. can be used to detect a speed of the output shaft 214 of the electric motor 202. Torque output is proportional to magnetic flux, which is proportional to current. Thus, torque output of the electric motor 202 can be derived by measuring current flowing to a motor inverter drive. The camera and/or imaging sensor can be used to detect a towing condition, an off-road condition, a grade condition, etc. In some examples, a grade of a road can be determined by detecting an orientation of the electric vehicle from feedback signals of an accelerometer, imaging processing, etc.

FIG. 3A is a partial cutaway, side view of the example fluid coupling 210 of FIG. 2 with the clutch in an example disengaged position 302. FIG. 3B is a partial cutaway, side view of the example fluid coupling 210 of FIG. 3A with the clutch in an example engaged position 304. Referring to FIGS. 3A-3B, the clutch 212 slides in an axial direction relative to the front cover 230 via the pressure system to move the clutch 212 between the engaged position 304 and the disengaged position 302.

FIG. 4 is a block diagram of an example implementation of the rotor lock prevention circuitry 240 of FIG. 2. The rotor lock prevention circuitry 240 operates the fluid coupling 210 based on detected conditions of the electric vehicle 100. In some examples, the rotor lock prevention circuitry 240 can determine if one or more condition(s) of the electric vehicle 100 (e.g., a towing condition, an off-road condition, a hill hold condition, vehicle speed condition, and/or any other vehicle condition) can cause rotor lock and/or motor stall. The rotor lock prevention circuitry 240 of FIG. 4 may be instantiated (e.g., creating an instance of, bring into being for any length of time, materialize, implement, etc.) by programmable circuitry such as a Central Processor Unit (CPU) executing first instructions. Additionally or alternatively, the rotor lock prevention circuitry 240 of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

The example rotor lock prevention circuitry 240 of FIG. 4 includes example vehicle condition circuitry 402, example rotor lock prevention activation circuitry 404, example rotor lock identifier circuitry 406, example motor speed determiner circuitry 408, and example brake modulation circuitry 410. The example vehicle condition circuitry 402 further includes example tow mode detection circuitry 412, example off-road detection circuitry 414, example grade detection circuitry 416, example vehicle speed detection circuitry 418, example torque command circuitry 420, example motor speed detection circuitry 422, example motor torque determiner circuitry 424 and example inverter phase current detection circuitry 426.

The example vehicle condition circuitry 402 determines a condition of the electric vehicle 100 based on information (e.g., one or more feedback signals) provided by the sensor(s) 260, a user input (e.g., a human machine interface), the MCU 262 and/or any other system(s) of the example electric vehicle 100. In some examples, the vehicle condition circuitry 402 can determine a condition of the electric vehicle 100 including, for example, a tow condition, an off-road condition, a hill hold condition, a standstill condition, a temperature condition, and/or any other vehicle condition(s). In other examples, the vehicle condition circuitry 402 can include any other circuitry for detecting a condition of the electric vehicle 100 associated with and/or that can cause rotor lock condition(s).

The tow mode detection circuitry 412 of the illustrated example determines if the electric vehicle 100 is in a towing mode or condition. For example, the tow mode detection circuitry 412 can determine that the electric vehicle 100 is in a towing mode by detecting a trailer light connection with the electric vehicle 100. For example, a trailer light module or connector of the electric vehicle 100 can include a sensor that provides feedback to the MCU 262 and/or the tow mode detection circuitry 412 indicative of trailer lights (e.g., an electrical connection) coupled to the module connector. In some examples, the tow mode detection circuitry 412 can determine if the electric vehicle 100 is in a towing mode based on image recognition or image feedback provided by the sensor(s) 260 (e.g., cameras) of the electric vehicle 100. In some examples, the tow mode detection circuitry 412 detects a tow mode based on a user input provided by a human machine/user interface (e.g., a push button in the cabin of the electric vehicle 100).

The off-road mode detecting circuitry 414 determines if the electric vehicle 100 is in an off-road mode and/or off-road condition. For example, the off-road mode detection circuitry 414 can determine if the electric vehicle 100 is in an off-road mode based on image recognition or image feedback provided by the sensor(s) 260 (e.g., cameras) of the electric vehicle 100. In some examples, the off-road mode detection circuitry 414 detects an off-road mode based on a user input provided by a human machine/user interface (e.g., a push button in the cabin of the electric vehicle 100).

The grade detection circuitry 416 detects an orientation of the electric vehicle 100. For example, the grade detection circuitry 416 receives feedback signals from an accelerometer of the electric vehicle 100 that detects an orientation (e.g., a pitched, angled, or inclined orientation) of the electric vehicle 100. The orientation of the electric vehicle 100 is indicative of an angle of the road or path. In other examples, the grade detection circuitry 416 can detect a grade of a road by processing images captured by a camera of the electric vehicle 100.

The vehicle speed detection circuitry 418 determines a vehicle speed of the electric vehicle 100. For example, the vehicle speed detection circuitry 418 can receive vehicle speed information from the MCU 262 and/or can receive feedback signals from one or more sensor(s) 260 and/or any other component(s) of the electric vehicle 100.

The torque command circuitry 420 determines a torque command provided by a user of a driver. For example, the torque command circuitry 420 receives torque command values from the MCU 262. For example, the torque command values are provided by a user's interaction with a pedal of the electric vehicle 100.

The motor speed detection circuitry 422 determines, receives, and/or otherwise obtains motor speed output of the electric motor 202. For example, the motor speed detection circuitry 422 receives motor speed values from the MCU 262, and/or one or more sensor(s) 260 (e.g., hall effect sensors, encoders, resolvers) employed to detect a speed of the output shaft 214 of the electric motor 202.

The motor torque determiner circuitry 424 determines, receives, and/or otherwise obtains motor torque output of the electric motor 202. For example, the motor torque determiner circuitry 424 receives motor torque values from the MCU 262. In some examples, the motor torque determiner circuitry 424 calculates motor torque output based on a measured current of the electric motor 202. For example, torque output is proportional to magnetic flux, which is proportional to current. Thus, torque output of the electric motor 202 can be derived by measuring current flowing to a motor inverter drive.

The inverter phase current detection circuitry 426 determines, receives, and/or otherwise obtains current values flowing to the electric motor 202 and/or an inverter of the electric motor 202. In some examples, the inverter phase current detection circuitry 426 receives current consumption information from the MCU 262. In some examples, the inverter phase current detection circuitry 426 receives measured current values from the electric motor 202.

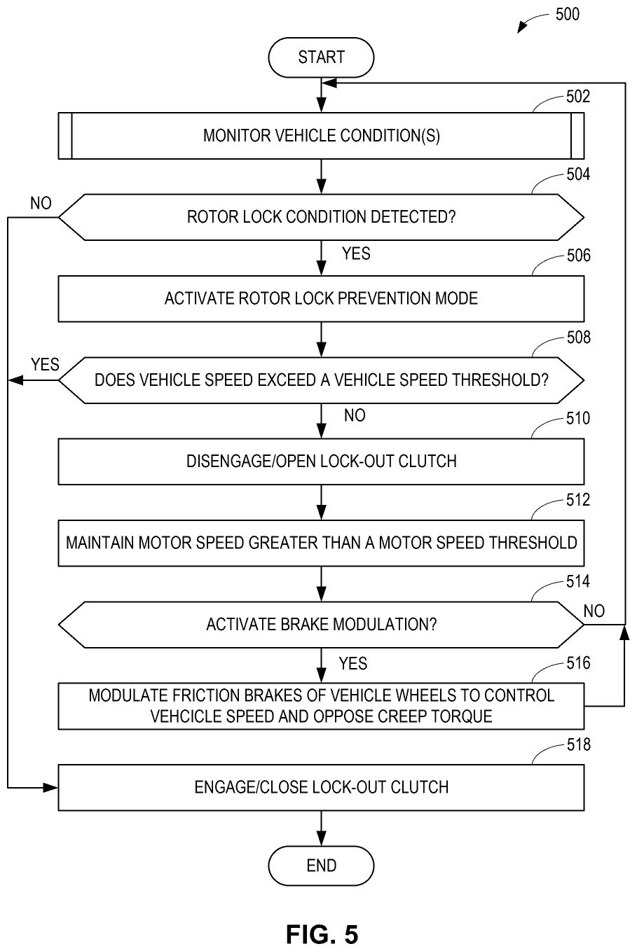

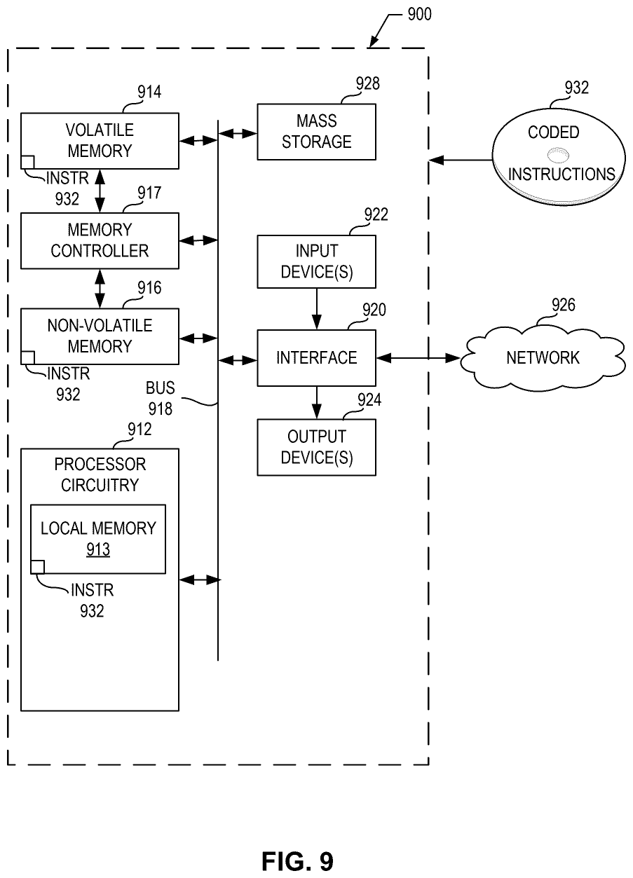

In some examples, the vehicle condition circuitry 402 (e.g., the example tow mode detection circuitry 412, the example off-road detection circuitry 414, the example grade detection circuitry 416, the example vehicle speed detection circuitry 418, the example torque command circuitry 420, the example motor speed detection circuitry 422, the example motor torque determiner circuitry 424, the example inverter phase current detection circuitry 426) is instantiated by programmable circuitry executing vehicle condition circuitry instructions and/or configured to perform operations such as those represented by the flowcharts of FIGS. 5-8. In some examples, the vehicle condition circuitry 402 includes means for determining an operating condition of the electric vehicle 100. For example, the means for determining may be implemented by the vehicle condition circuitry 402. In some examples, the vehicle condition circuitry 402 may be instantiated by programmable circuitry such as the example programmable circuitry 900 of FIG. 9. For instance, the vehicle condition circuitry 402 may be instantiated by a microprocessor executing machine executable instructions such as those implemented by at least blocks 912, 914, 916 of FIG. 9. In some examples, the vehicle condition circuitry 402 may be instantiated by hardware logic circuitry, which may be implemented by an ASIC, XPU, or the FPGA circuitry configured and/or structured to perform operations corresponding to the machine readable instructions. Additionally or alternatively, the vehicle condition circuitry 402 may be instantiated by any other combination of hardware, software, and/or firmware. For example, the vehicle condition circuitry 402 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example rotor lock prevention activation circuitry 404 activates a rotor lock prevention mode of the electric vehicle 100 based on the detected vehicle condition determined by the vehicle condition circuitry 402. For example, the rotor lock prevention activation circuitry 404 determines whether the vehicle condition detected by the vehicle condition circuitry 402 is associated with and/or indicative of a potential rotor lock condition. In some examples, the rotor lock prevention activation circuitry 404 can employ a look-up table to determine if a detected condition is indicative of a potential rotor lock condition. For example, the rotor lock prevention activation circuitry 404 can activate the rotor lock prevention mode in response to detecting a vehicle speed is less than a vehicle speed threshold (e.g., 5 mph), the electric vehicle 100 is in a tow mode, the electric vehicle 100 is an off-road mode, the electric vehicle 100 is on a grade greater than a grade threshold, a torque output of the electric motor 202 is greater than a torque threshold, a motor speed of the electric motor 202 is less than a motor speed threshold (e.g., 500 rpms), an inverter phase current is greater than a current threshold, and/or any other condition or parameter(s) of the electric vehicle 100. In some examples, the rotor lock prevention activation circuitry 404 initiates a control logic (e.g., and/or enables the rotor lock prevention identification circuitry 406) to monitor and/or check a vehicle speed of the electric vehicle 100.

In some examples, the rotor lock prevention activation circuitry 404 is instantiated by programmable circuitry executing instructions and/or configured to perform operations such as those represented by the flowcharts of FIGS. 5-8. In some examples, the rotor lock prevention activation circuitry 404 includes means for activating rotor lock prevention circuitry if the detected vehicle condition is indicative of potential rotor stall conditions. For example, the means for activating rotor lock prevention circuitry may be implemented by the rotor lock prevention activation circuitry 404. In some examples, the rotor lock prevention activation circuitry 404 may be instantiated by programmable circuitry such as the example programmable circuitry 900 of FIG. 9. For instance, the rotor lock prevention activation circuitry 404 may be instantiated by a microprocessor executing machine executable instructions such as those implemented by at least blocks 912, 914, 916 of FIG. 9. In some examples, the rotor lock prevention activation circuitry 404 may be instantiated by hardware logic circuitry, which may be implemented by an ASIC, XPU, or the FPGA circuitry configured and/or structured to perform operations corresponding to the machine readable instructions. Additionally or alternatively, the rotor lock prevention activation circuitry 404 may be instantiated by any other combination of hardware, software, and/or firmware. For example, the rotor lock prevention activation circuitry 404 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The rotor lock identifier circuitry 406 determines whether the vehicle condition is a rotor lock condition. For example, the rotor lock identifier circuitry 406 compares one or more conditions or signals from the vehicle condition circuitry 402, the MCU 262, the sensor(s) 260 and/or other systems of the electric vehicle 100. For example, the rotor lock identifier circuitry 406 compares one or more of a vehicle speed, a motor speed, a motor torque, an inverter phase current, a torque command/torque output mismatch, a vehicle speed/torque command mismatch, and/or any other parameters) to threshold values to determine if the vehicle condition identified by the vehicle condition monitor circuitry 402 can be indicative of rotor lock and/or motor stall. In some examples, the rotor lock identifier circuitry 406 compares one or more measured or detected values or parameters and threshold associated with a correlation values 428. In some examples, the rotor lock identifier circuitry 406 obtains or determines a threshold (e.g., a motor speed threshold, a motor torque threshold, etc.) from the correlation values 428. For example, the correlation values 428 can include motor speed to torque values, motor current to speed values, motor current to motor torque values, vehicle speed to motor speed values, and/or any other values. For example, the rotor lock identifier circuitry 406 can employ the correlation values 428 to operate the electric motor 202 at motor speeds (e.g., RPMs) associated with a motor toque corresponding to a torque demand value generated by a user of the electric vehicle 100 based on a vehicle speed.

Based on the vehicle condition and/or other parameters of the electric vehicle 100 provided by the vehicle condition circuitry 402, the MCU, the sensor(s) and/or other systems of the electric vehicle 100, the rotor lock identifier circuitry 406 determines whether to move the clutch 212 to the engaged position 304 or disengaged position 302. The rotor lock identifier circuitry 406 commands, instructions and/or otherwise causes the clutch 212 to move to the disengaged position 302 in response to determining that a rotor lock condition exists and the engaged position 304 in response to determining that a rotor lock condition does not exist. For example, the rotor lock identifier circuitry 406 commands, instructs, and/or otherwise causes the solenoid 254 to move between the open position and the closed position to move the valve 252 between the first position and the second position and, thus, move the clutch 212 between the disengaged position 302 and the engaged position 304.

In some examples, the rotor lock identifier circuitry 406 is instantiated by programmable circuitry executing instructions and/or configured to perform operations such as those represented by the flowcharts of FIGS. 5-8. In some examples, the rotor lock identifier circuitry 406 includes means for determining a rotor lock condition of the electric vehicle 100. For example, the means for determining may be implemented by the rotor lock identifier circuitry 406. In some examples, the rotor lock identifier circuitry 406 may be instantiated by programmable circuitry such as the example programmable circuitry 900 of FIG. 9. For instance, the rotor lock identifier circuitry 406 may be instantiated by a microprocessor executing machine executable instructions such as those implemented by at least blocks 912, 914, 916 of FIG. 9. In some examples, the rotor lock identifier circuitry 406 may be instantiated by hardware logic circuitry, which may be implemented by an ASIC, XPU, or the FPGA circuitry configured and/or structured to perform operations corresponding to the machine readable instructions. Additionally or alternatively, the rotor lock identifier circuitry 406 may be instantiated by any other combination of hardware, software, and/or firmware. For example, the rotor lock identifier circuitry 406 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example motor speed determiner circuitry 408 determines, commands and/or causes the electric motor 202 to operate at a motor speed operating threshold based on the vehicle condition determined by the rotor lock identifier circuitry 406. For example, when the clutch 212 is in the disengaged position 302, the motor speed determiner circuitry 408 determines a minimum motor operating speed. Specifically, the minimum motor operating speed is a motor speed that is greater than a minimum motor speed threshold associated with a full torque capability of the electric motor 202. For example, the correlation values 428 can include speed-to-torque values indicative of a minimum speed (e.g., 500 rpm) of the electric motor 202 to prevent locked rotor torque and output a full nominal torque capability based on a vehicle speed and/or condition of the electric vehicle 100. In some examples, the motor speed determiner circuitry 408 causes the electric motor 202 to operate at a minimum motor speed threshold (e.g., greater than 500 rpm) or greater when the clutch 212 is in the disengaged position 302. For example, motor speed determiner circuitry 408 causes the MCU 262 to operate the electric motor 202 based on a motor speed value determined by the motor speed determiner circuitry 408. In some examples, the motor speed determiner circuitry 408 maintains a motor speed based on a torque command (e.g., detected by the torque command circuitry 420. For instance, when the clutch 212 is open/disengaged and the fluid coupling 210 is “slipping”, a torque output is dynamic (e.g., based on level of slip). Thus, instead of torque based control, motor speed determiner circuitry 408 controls motor speed with a minimum motor speed threshold to maintain a commanded vehicle speed.

In some examples, the motor speed determiner circuitry 408 is instantiated by programmable circuitry executing instructions and/or configured to perform operations such as those represented by the flowcharts of FIGS. 5-8. In some examples, the motor speed determiner circuitry 408 includes means for determining motor speed values when the clutch 212 is in the disengaged position 302 and/or the electric vehicle 100 is in a rotor lock condition determined by the vehicle condition circuitry 402, the rotor lock prevention activation circuitry 404 and/or the rotor lock identifier circuitry 406. For example, the means for determining may be implemented by the motor speed determiner circuitry 408. In some examples, the motor speed determiner circuitry 408 may be instantiated by programmable circuitry such as the example programmable circuitry 900 of FIG. 9. For instance, the motor speed determiner circuitry 408 may be instantiated by a microprocessor executing machine executable instructions such as those implemented by at least blocks 912, 914, 916 of FIG. 9. In some examples, the motor speed determiner circuitry 408 may be instantiated by hardware logic circuitry, which may be implemented by an ASIC, XPU, or the FPGA circuitry configured and/or structured to perform operations corresponding to the machine readable instructions. Additionally or alternatively, the motor speed determiner circuitry 408 may be instantiated by any other combination of hardware, software, and/or firmware. For example, the motor speed determiner circuitry 408 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example brake modulation circuitry 410 determines whether to modulate brakes (e.g., friction brakes) to control vehicle speed and/or oppose creep torque from the fluid coupling 210. For example, the brake modulation circuitry 410 determines brake modulation when the off-road mode detection circuitry 414 determines that the vehicle condition is an off-road condition and the rotor lock identifier circuitry 406 caused the clutch 212 to move to the disengaged position 302. The brake modulation circuitry 410 can receive vehicle speed information from the vehicle speed detection circuitry 418 when determining an amount of modulation needed to control the vehicle speed to a target vehicle speed value.

In some examples, the brake modulation circuitry 410 is instantiated by programmable circuitry executing brake modulation circuitry instructions and/or configured to perform operations such as those represented by the flowcharts of FIGS. 5-8. In some examples, the brake modulation circuitry 410 includes means for determining a brake modulation based on the detected rotor lock condition and/or the off-road mode detection circuitry 414. For example, the means for determining may be implemented by the brake modulation circuitry 410. In some examples, the brake modulation circuitry 410 may be instantiated by programmable circuitry such as the example programmable circuitry 900 of FIG. 9. For instance, the brake modulation circuitry 410 may be instantiated by a microprocessor executing machine executable instructions such as those implemented by at least blocks 912, 914, 916 of FIG. 9. In some examples, the brake modulation circuitry 410 may be instantiated by hardware logic circuitry, which may be implemented by an ASIC, XPU, or the FPGA circuitry configured and/or structured to perform operations corresponding to the machine readable instructions. Additionally or alternatively, the brake modulation circuitry 410 may be instantiated by any other combination of hardware, software, and/or firmware. For example, the brake modulation circuitry 410 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the rotor lock prevention circuitry 240 of FIG. 2 is illustrated in FIG. 4, one or more of the elements, processes, and/or devices illustrated in FIG. 4 may be combined, divided, re-arranged, omitted, eliminated, and/or implemented in any other way. Further, the example vehicle condition circuitry 402, the example rotor lock prevention activation circuitry 404, the example rotor lock identifier circuitry 406, the example motor speed determiner circuitry 408, the example brake modulation circuitry 410, the example tow mode detection circuitry 412, the example off-road detection circuitry 414, the example grade detection circuitry 416, the example vehicle speed detection circuitry 418, the example torque command circuitry 420, the example motor speed detection circuitry 422, the example motor torque determiner circuitry 424 and the example inverter phase current detection circuitry 426 and/or, more generally, the example rotor lock prevention circuitry 240 of FIG. 4, may be implemented by hardware alone or by hardware in combination with software and/or firmware. Thus, for example, any of the example vehicle condition circuitry 402, the example rotor lock prevention activation circuitry 404, the example rotor lock identifier circuitry 406, the example motor speed determiner circuitry 408, the example brake modulation circuitry 410, the example tow mode detection circuitry 412, the example off-road detection circuitry 414, the example grade detection circuitry 416, the example vehicle speed detection circuitry 418, the example torque command circuitry 420, the example motor speed detection circuitry 422, the example motor torque determiner circuitry 424 and the example inverter phase current detection circuitry 426 and/or, more generally, the example rotor lock prevention circuitry 240 of FIG. 4, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example rotor lock prevention circuitry 240 of FIG. 4 may include one or more elements, processes, and/or devices in addition to, or instead of, those illustrated in FIG. 4, and/or may include more than one of any or all of the illustrated elements, processes, and devices.

Flowcharts representative of example machine readable instructions, which may be executed by programmable circuitry to implement and/or instantiate the example rotor lock prevention circuitry 240 of FIG. 4 and/or representative of example operations which may be performed by programmable circuitry to implement and/or instantiate the example rotor lock prevention circuitry 240 of FIG. 4, are shown in FIGS. 5-8. The machine readable instructions may be one or more executable programs or portion(s) of one or more executable programs for execution by programmable circuitry such as the programmable circuitry 912 shown in the example programmable circuitry platform 900 discussed below in connection with FIG. 9 and/or may be one or more function(s) or portion(s) of functions to be performed by the example programmable circuitry. In some examples, the machine readable instructions cause an operation, a task, etc., to be conducted and/or performed in an automated manner in the real world. As used herein, “automated” means without human involvement.

The program(s) may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 5-8, many other methods of implementing the example rotor lock prevention circuitry 240 of FIG. 4 may alternatively be used. For example, the order of execution of the blocks of the flowcharts may be changed, and/or some of the blocks described may be changed, eliminated, duplicated, or combined. Additionally or alternatively, any or all of the blocks of the flow chart may be implemented by one or more hardware circuits (e.g., processor circuitry, discrete and/or integrated analog and/or digital circuitry, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks, and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 5-8 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic, and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or RAID systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

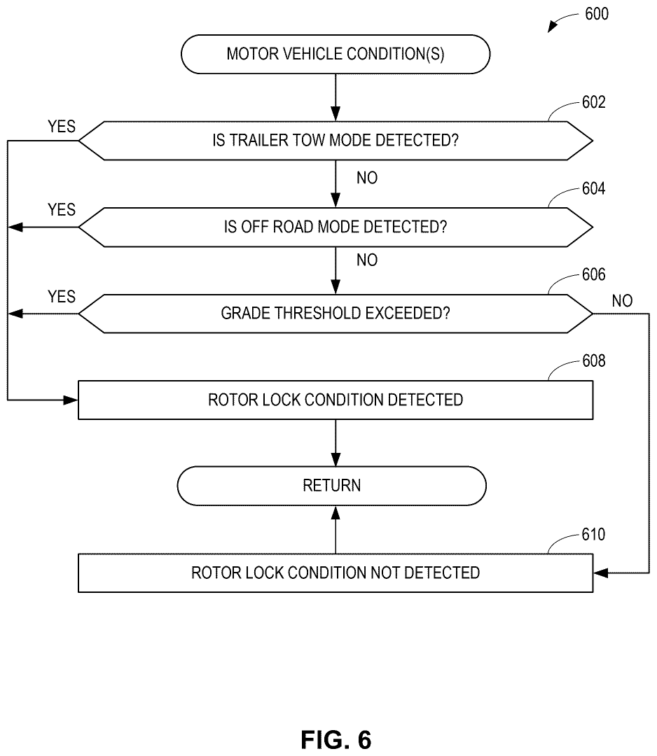

FIG. 5 is a flowchart representative of example machine readable instructions and/or example operations 500 that may be executed, instantiated, and/or performed by example programmable circuitry to detect rotor lock conditions of the electric vehicle 100. The example machine-readable instructions and/or the example operations 500 of FIG. 5 begin at block 502, at which the example vehicle condition circuitry 402 monitors and/or determines a vehicle condition. For example, the vehicle condition circuitry 402 determines whether the electric vehicle 100 is in a towing mode, an off-road mode, an inclined grade condition, vehicle speed, torque command, motor speed, inverter phase current and/or any other vehicle condition(s) and/or parameter(s). Some example vehicle condition detection operations are described in FIGS. 6-8.

At block 504, the rotor lock prevention activation circuitry 404 determines whether to activate the rotor lock prevention mode. For example, the rotor lock prevention activation circuitry 404 determines if the vehicle condition(s) detected by the vehicle condition circuitry 402 at block 502 can potentially cause a rotor lock condition. In some examples, the rotor lock prevention activation circuitry 404 compares one or more detected condition(s) and/or parameter(s) provided by the vehicle condition circuitry 402 to thresholds and/or look-up tables to determine whether the detected condition(s) and/or parameter(s) cause activation of the rotor lock prevention mode.

If at block 504 the rotor lock prevention activation circuitry 404 determines that the detected vehicle condition(s) at block 502 does not cause a rotor lock condition, then the rotor lock prevention activation circuitry 404 and/or the rotor lock identifier circuitry 406 commands, instructions and/or otherwise causes the solenoid 254 to move to the second position to engage/close the clutch 212 (block 518). In the engaged position, the clutch 212 bypasses the fluid coupling 210 and enables the output shaft 214 of the electric motor 202 mechanically couple to the drive shaft 216.

If at block 504 the rotor lock prevention activation circuitry 404 determines that the detected vehicle condition(s) at block 502 can potentially cause a rotor lock condition, then the rotor lock prevention activation circuitry 404 activates the rotor lock prevention mode (block 506). Activation of the rotor lock prevention mode enables the rotor lock identifier circuitry 406 to monitor for rotor lock.

At block 508, the rotor lock identifier circuitry 406 determines if the vehicle speed exceeds a vehicle speed threshold. In some examples, the vehicle speed threshold can be a predetermined value (e.g., 5 miles per hour (mph)). In some examples, the vehicle speed threshold can be determined from a look-up table such as, for example, the correlation values 428.

If at block 508 the rotor lock identifier circuitry 406 determines that the vehicle speed exceeds the vehicle speed threshold, then the rotor lock identifier circuitry 406 determines that the detected condition(s) and/or parameter(s) provided by the vehicle condition circuitry 402 do not cause rotor lock and commands, instructions and/or otherwise causes the solenoid 254 to move to the second position to engage/close the clutch 212 (block 518).

If at block 508 the rotor lock identifier circuitry 406 determines that the vehicle speed does not exceed the vehicle speed threshold, then the rotor lock identifier circuitry 406 commands, instructions and/or otherwise causes the clutch 212 to move to the disengaged position 302 (e.g., an open position) to enable the fluid coupling 210 (block 510). For example, the rotor lock identifier circuitry 406 determines or identifies that the detected condition(s) and/or parameter(s) provided by the vehicle condition circuitry 402 can cause rotor lock and commands, instructions and/or otherwise causes the solenoid 254 to move to the first position to disengage/open the clutch 212. In the disengaged position, the clutch 212 enables the fluid coupling 210 to enable slip between the output shaft 214 and the drive shaft 216.

At block 512, the motor speed determiner circuitry 408 determines and/or maintains a motor speed of the electric motor 202 greater than a motor speed threshold. In some examples, the motor speed threshold is a predetermined motor speed value based on performance characteristics of the electric motor 202. In some examples, the motor speed determiner circuitry 408 and/or the MCU 262 employ a closed loop speed control to control a motor speed of the electric motor 202 based on the motor speed threshold (e.g., maintains a threshold motor speed or greater). For example, the motor speed threshold can be 500 RPM. In some examples, the rotor lock identifier circuitry 406 maintains a motor speed that is at least equal to or greater than the motor speed threshold. In some examples, the motor speed threshold can be dynamically determined by the rotor lock identifier circuitry 406. For example, a motor speed threshold can be a minimum motor speed needed to achieve full torque capability of the electric motor 202. For example, the motor speed threshold can be determined based on a vehicle speed of the electric vehicle 100 determined by the vehicle speed detection circuitry 418 and/or a torque command determined by the torque command circuitry 420. In some examples, the motor speed threshold can be determined from a look-up table such as, for example, the correlation values 428. In some examples, the motor speed determiner circuitry 408 commands the MCU 262 to operate the electric motor 202 at the determined motor speed. In some examples, the motor speed determiner circuitry 408 (e.g., overrides the MCU 262 and) controls the motor speed of the electric motor 202.

At block 514, the brake modulation circuitry 410 determines whether to activate brake modulation. For example, the brake modulation circuitry 410 determines whether brake modulation is needed to control vehicle speed in response to maintaining the motor speed at the motor speed threshold (e.g., when the vehicle is at a standstill or traveling at low speeds (e.g., less than 5 mph). Specifically, the brake modulation circuitry 410 determines if the vehicle condition provided by the vehicle condition circuitry 402 is indicative of an off-road condition and/or off-road mode. For example, brake modulation may be needed during an off-road condition and may not be needed during a non-off-road condition.

If at block 514 the brake modulation circuitry 410 determines that brake modulation is needed, the brake modulation circuitry 410 commands, instructs, and/or otherwise causes the vehicle brake actuator 430 to modulate frictional brakes of the wheels 220 to control vehicle speed and/or oppose creep torque generated by the fluid coupling 210 (block 516). If at block 514 the brake modulation circuitry 410 determines that brake modulation is not needed, the process returns to block 502.

FIG. 6 is a flowchart representative of example machine readable instructions and/or example operations 600 that may be executed, instantiated, and/or performed by example programmable circuitry to monitor vehicle conditions of the electric vehicle 100. The example machine-readable instructions and/or the example operations 600 of FIG. 6 begin at block 602, at which the vehicle condition circuitry 402 monitors and/or determines if a trailer tow mode is detected. For example, to determine a tow mode or towing condition, the tow mode detection circuitry 412 determines if trailer lights are connected to the electric vehicle 100, a user input is indicative of a tow mode, and/or image recognition is indicative of a towing condition. If at block 602 a trailer mode is detected, then a rotor lock condition is detected (block 608). If at block 602 a trailer mode is not detected, then a rotor lock condition is not detected (block 610).

If a tow mode is not detected at block 602, the vehicle condition circuitry 402 monitors for an off-road condition and/or determines if an off-road mode is detected (block 604). For example, to determine an off-road mode or an off-road condition, the off-road mode detection circuitry 414 determines if a user input is indicative of an off-road mode and/or image recognition is indicative of an off-road condition. If at block 604 an off-road mode is detected, then a rotor lock condition is detected (block 608). If at block 604 an off-road mode is not detected, then a rotor lock condition is not detected (block 610).

If an off-road mode or condition is not detected at block 604, the vehicle condition circuitry 402 monitors and/or determines if a detected grade exceeds a grade threshold (block 606). For example, the grade detection circuitry 416 receives, retrieves, or otherwise obtains signals (e.g., feedback signals) from an accelerometer of the electric vehicle 100. The grade detection circuitry 416 compares the detected or measured grade to a grade threshold to determine if the grade exceeds the grade threshold. For example, the grade threshold can be a pre-determined value of approximately 20 degrees, 30 degrees, etc. relative to horizontal. If at block 606 a grade threshold is exceed, then a rotor lock condition is detected (block 608). If at block 606 a grade threshold is not exceed, then a rotor lock condition is not detected (block 610).

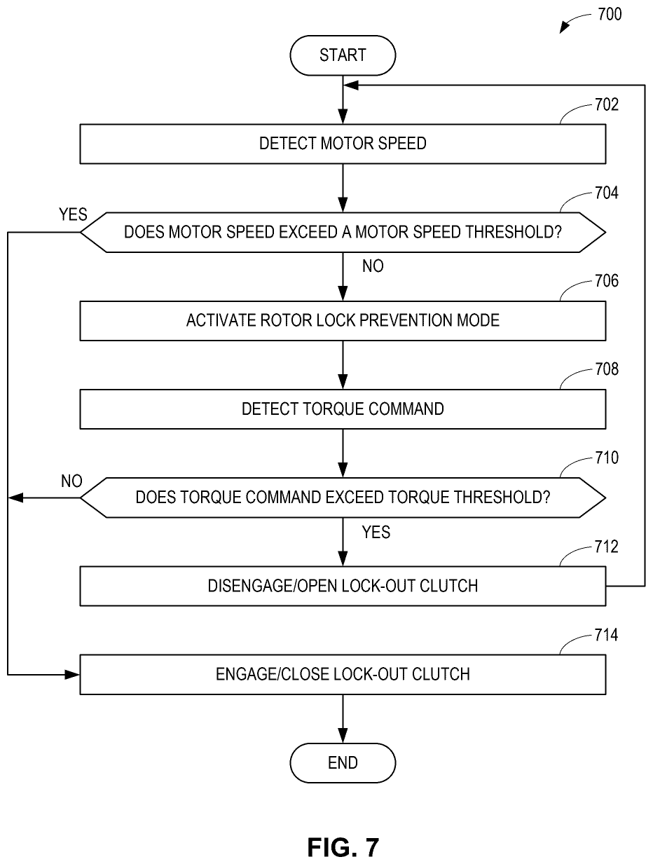

FIG. 7 is a flowchart representative of example machine readable instructions and/or example operations 700 that may be executed, instantiated, and/or performed by example programmable circuitry to detect rotor lock conditions of the electric vehicle 100. For example, the flowchart of FIG. 7 can be used to detect a motor stall condition of the example electric motor 202. The example machine-readable instructions and/or the example operations 700 of FIG. 7 begin at block 702, at which the vehicle condition circuitry 402 monitors and/or detects a motor speed of the electric motor 202. For example, the motor speed detection circuitry 422 detects, retrieves, obtains, and/or otherwise determines a motor speed of the electric motor 202.

The rotor lock prevention activation circuitry 404 determines if the motor speed exceeds a motor speed threshold (block 704). For example, the rotor lock prevention activation circuitry 404 employs a comparator to determine if the motor speed exceeds a motor speed threshold.

If at block 704 the rotor lock prevention activation circuitry 404 determines that the motor speed provided by the motor speed detection circuitry 422 does not exceed the motor speed threshold, the rotor lock prevention activation circuitry 404 determines a potential rotor lock condition and activates the rotor lock prevention monitoring mode (block 706).

The rotor lock identifier circuitry 406 then detects a torque command (block 708). For example, the rotor lock identifier circuitry 406 receives and/or otherwise obtains a torque command from the torque command circuitry 420, which monitors and/or retrieves a torque command from the MCU 262 and/or other sensor(s) 260.

At block 710, the rotor lock identifier circuitry 406 determines if the torque command exceeds a torque threshold. For example, the rotor lock identifier circuitry 406 employs a comparator to compare the torque command and the torque threshold. In some examples, the torque threshold is a predetermined torque threshold value (e.g., 100 Newton-meter (Nm), 440 (Nm), 560 (Nm), etc.). In some examples, the torque threshold is retrieved from a look-up table and/or the correlation values 428 of FIG. 4. For example, the torque threshold can be based on or associated with (e.g., is dependent on) the detected motor speed. Thus, the torque threshold can be predetermined and/or can be determined dynamically during operation of the electric vehicle 100.

If at block 710 the rotor lock identifier circuitry 406 determines that the torque command exceeds the torque threshold, then the rotor lock identifier circuitry 406 determines a rotor lock condition and commands, instructions and/or otherwise causes the clutch 212 to move to the disengaged position 302 (e.g., an open position) to enable the fluid coupling 210 (block 712). For example, if at block 704 the vehicle condition circuitry 402 detects that the motor speed is zero and at block 708 the torque command is 100 Nm, then the rotor lock identifier circuitry 406 detects a rotor lock condition and causes the clutch 212 to disengage the front cover 230 to enable a fluid coupling between the output shaft 214 and the drive shaft 216 via the fluid coupling 210. The process returns to block 702.

If at block 704 the motor speed exceeds the motor speed threshold or at block 710 the torque command does not exceed the torque threshold, then the rotor lock identifier circuitry 406 does not identify a rotor lock condition and commands, instructs, and/or otherwise causes the clutch 212 to move to the engaged position 304 to bypass the fluid coupling 210 (block 714).

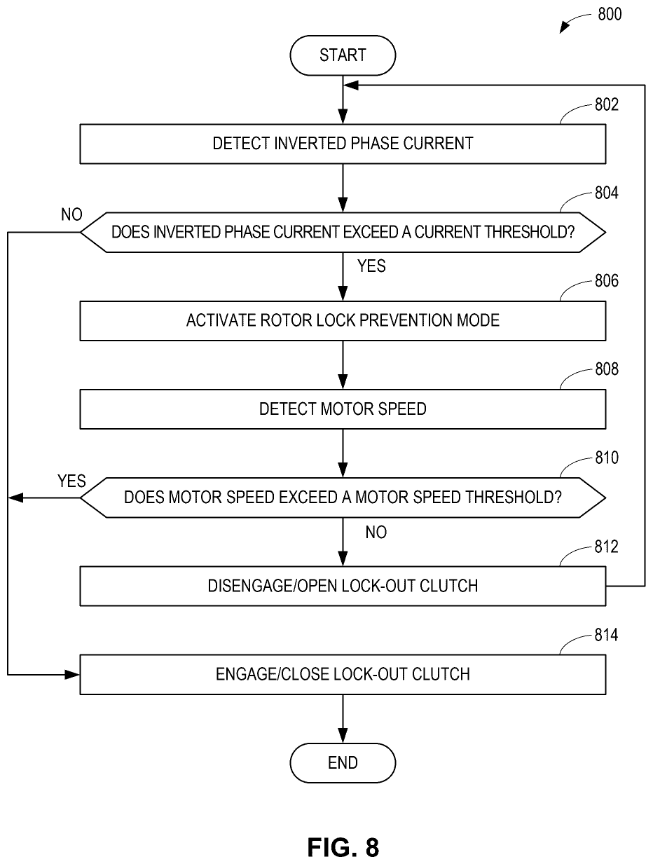

FIG. 8 is a flowchart representative of example machine readable instructions and/or example operations 800 that may be executed, instantiated, and/or performed by example programmable circuitry to detect rotor lock conditions of the electric vehicle 100. For example, the flowchart of FIG. 8 can be used to detect an inverter fault condition of the inverter of the example electric motor 202. The example machine-readable instructions and/or the example operations 800 of FIG. 8 begin at block 802, at which the example vehicle condition circuitry 402 monitors and/or detects an inverter phase current. For example, the inverter phase current detection circuitry 426 detects, retrieves, obtains, and/or otherwise determines an inverter phase current from the MCU 262 and/or the electric motor 202.

The rotor lock prevention activation circuitry 404 determines if the inverter phase current exceeds a current threshold (block 804). For example, the rotor lock prevention activation circuitry 404 employs a comparator to determine if the inverter phase current exceeds the current threshold.

If the inverter phase current exceeds the current threshold at block 804, then the rotor lock prevention activation circuitry 404 determines that a rotor lock condition is detected and activates the rotor lock prevention mode (block 806).

The rotor lock identifier circuitry 406 then detects a motor speed (block 808). For example, the rotor lock identifier circuitry 406 receives and/or otherwise obtains a motor speed from the motor speed detection circuitry 422.

At block 810, the rotor lock identifier circuitry 406 determines if the motor speed exceeds a motor speed threshold. For example, the rotor lock identifier circuitry 406 employs a comparator to compare the motor speed and the motor speed threshold.

If at block 810 the rotor lock identifier circuitry 406 determines that the motor speed does not exceeds the motor speed threshold, then the rotor lock identifier circuitry 406 determines a rotor lock condition and commands, instructions and/or otherwise causes the clutch 212 to move to the disengaged position 302 (e.g., an open position) to enable the fluid coupling 210 (block 812). The process returns to block 802.

If at block 804 the inverter phase current does not exceed the current threshold or at block 810 the motor speed exceeds the motor speed threshold, then the rotor lock identifier circuitry 406 commands, instructs and/or otherwise causes the clutch 212 to move to the engaged position to bypass the fluid coupling 210 (block 814).

The foregoing examples of the machine readable instructions and/or example operations 500-800 can be employed by the anti-rotor circuitry 220 to implement rotor lock prevention systems. Although each example machine readable instructions and/or example operations 500-800 disclosed above have certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

FIG. 9 is a block diagram of an example programmable circuitry platform 900 structured to execute and/or instantiate the example machine-readable instructions and/or the example operations of FIGS. 5-8 to implement the example rotor lock prevention circuitry 240 of FIGS. 2 and 4. The programmable circuitry platform 900 can be, for example, a server, a personal computer, a workstation, a self-learning machine (e.g., a neural network), a mobile device (e.g., a cell phone, a smart phone, a tablet), or other wearable device, or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, microprocessors, CPUs, GPUs, DSPs, and/or microcontrollers from any desired family or manufacturer. The programmable circuitry 912 may be implemented by one or more semiconductor based (e.g., silicon based) devices. In this example, the programmable circuitry 912 implements the example rotor lock prevention circuitry 240, the example vehicle condition circuitry 402, the example rotor lock prevention activation circuitry 404, the example rotor lock identifier circuitry 406, the example motor speed determiner circuitry 408, the example brake modulation circuitry 410, the example tow mode detection circuitry 412, the example off-road detection circuitry 414, the example grade detection circuitry 416, the example vehicle speed detection circuitry 418, the example torque command circuitry 420, the example motor speed detection circuitry 422, the example motor torque determiner circuitry 424 and/or the example inverter phase current detection circuitry 426.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, a trackpad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, and/or speaker. The interface circuitry 920 of the illustrated example, thus, includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 932, which may be implemented by the machine readable instructions of FIGS. 5-8, may be stored in the mass storage device 928, in the volatile memory 914, in the non-volatile memory 916, and/or on at least one non-transitory computer readable storage medium such as a CD or DVD which may be removable.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time +1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that enable detection and/or prevention of rotor lock conditions associated with electric motors and/or electric vehicles. Further examples and combinations thereof include the following:

Example 1 includes an apparatus including an electric motor having an output shaft, a drive shaft to drive one or more wheels of a vehicle, a fluid torque converter to operatively couple the output shaft of the electric motor and the drive shaft, and a clutch movable between an engaged position and a disengaged position.

The clutch is to fluidly couple the output shaft of the electric motor and the drive shaft when the clutch is in the disengaged position. The clutch to enable the electric motor to bypass the fluid torque converter to mechanically couple the output shaft of the electric motor and the drive shaft when the clutch is in the engaged position.

Example 2 includes the apparatus of example 1, wherein the clutch is to enable slip between the output shaft of the electric motor and the drive shaft when the clutch is in the disengaged position, the clutch to prevent slip between the output shaft of the electric motor and the drive shaft when the clutch is in the engaged position.

Example 3 includes the apparatus of examples 1 or 2, wherein the clutch is to enable the output shaft of the electric motor to rotate a first speed different than a second speed of the drive shaft when the clutch is in the disengaged position, the clutch to enable the output shaft of the electric motor and the drive shaft to rotate at the same speed when the clutch is in the engaged position.

Example 4 includes the apparatus of any one of examples 1-3, further including a gearbox coupled between the output shaft of the electric motor and the fluid torque converter.

Example 5 includes the apparatus of any one of examples 1-4, further including a gearbox coupled between fluid torque converter and the drive shaft.

Example 6 includes the apparatus of any one of examples 1-5, wherein the fluid torque converter is a hydraulic torque converter.

Example 7 includes the apparatus of any one of examples 1-6, wherein the fluid torque converter includes a turbine and an impeller, wherein the impeller is coupled to the output shaft of the electric motor and the turbine is coupled to the drive shaft.

Example 8 includes the apparatus of any one of examples 1-7, wherein the clutch is slidably coupled to the turbine.

Example 9 includes the apparatus of any one of examples 1-7, further including a valve fluidly coupled to the clutch, the valve movable between a first position and a second position, in the first position, the valve to cause the clutch to move to the engaged position to mechanically couple the output shaft of the motor and the drive shaft, in the second position, the valve to cause the clutch to move to the disengaged position to fluidly couple the output shaft of the motor and the drive shaft.

Example 10 includes the apparatus of any one of examples 1-8, further including a controller to cause the valve to move to the second position in response to detecting a rotor lock condition of the vehicle and determining that a vehicle speed does not exceed a vehicle speed threshold.

Example 11 includes the apparatus of any one of examples 1-9, wherein the controller is to move the clutch to an open position to fluidly couple the output shaft and the drive shaft in response to detecting a rotor lock condition and determining that a motor speed of the electric motor does not exceed a motor speed threshold.

Example 12 includes the apparatus of any one of examples 1-10, further including a controller to cause the valve to move to the second position and operate the electric motor at least at a minimum motor speed threshold in response to detecting a rotor lock condition.

Example 13 includes an apparatus including interface circuitry, machine readable instructions, and programmable circuitry to at least one of instantiate or execute the machine readable instructions to: activate an rotor lock prevention mode based on a detected vehicle condition; compare a vehicle speed and a vehicle speed threshold; in response to the vehicle speed not exceeding the vehicle speed threshold: cause a lock-out clutch of a fluid torque converter to move to an open position; and maintain a motor speed of an electric motor greater than a motor speed threshold.

Example 14 includes the apparatus of example 13, wherein the programmable circuitry is to activate the rotor lock prevention mode if the detected vehicle condition is an off-road condition.

Example 15 includes the apparatus of examples 13 or 14, wherein the programmable circuitry is to at least one of instantiate or execute the machine readable instructions to modulate friction brakes of vehicle wheels in response to determining that the detected vehicle condition is in an off-road mode.

Example 16 includes the apparatus of any one of examples 13-15, wherein the programmable circuitry is to cause the lock-out clutch of the fluid torque converter to move to a closed position in response to determining that the vehicle speed exceeds the vehicle speed threshold.

Example 17 includes at least one non-transitory machine-readable medium comprising machine-readable instructions to cause at least one processor circuit to at least: monitor a vehicle condition; activate an rotor lock prevention mode if a detected vehicle condition includes a rotor lock condition; after activation of the rotor lock prevention mode, compare a vehicle speed and a vehicle speed threshold; in response to the vehicle speed not exceeding the vehicle speed threshold: cause a lock-out clutch of a fluid torque converter to move to an open position; and maintain a motor speed of an electric motor greater than a motor speed threshold.

Example 18 includes the at least one non-transitory machine-readable medium of example 17, wherein the machine-readable instructions are to cause modulation of friction brakes of vehicle wheels in response to determining that the vehicle condition is an off-road condition.

Example 19 includes the at least one non-transitory machine-readable medium of examples 17 or 18, wherein the machine-readable instructions are to cause the lock-out clutch of the fluid torque converter to move to a closed position in response to determining that the vehicle speed exceeds the vehicle speed threshold.

Example 20 includes the at least one non-transitory machine-readable medium of any one of examples 17-19, wherein the machine-readable instructions are to cause the lock-out clutch of the fluid torque converter to move to a closed position in response to determining that the vehicle condition is not a rotor lock condition.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
an electric motor having an output shaft;
a drive shaft to drive one or more wheels of a vehicle;
a fluid torque converter to operatively couple the output shaft of the electric motor and the drive shaft; and
a clutch movable between an engaged position and a disengaged position, the clutch to fluidly couple the output shaft of the electric motor and the drive shaft when the clutch is in the disengaged position, the clutch to enable the electric motor to bypass the fluid torque converter to mechanically couple the output shaft of the electric motor and the drive shaft when the clutch is in the engaged position.

2. The apparatus of claim 1, wherein the clutch is to enable slip between the output shaft of the electric motor and the drive shaft when the clutch is in the disengaged position, the clutch to prevent slip between the output shaft of the electric motor and the drive shaft when the clutch is in the engaged position.

3. The apparatus of claim 1, wherein the clutch is to enable the output shaft of the electric motor to rotate a first speed different than a second speed of the drive shaft when the clutch is in the disengaged position, the clutch to enable the output shaft of the electric motor and the drive shaft to rotate at the same speed when the clutch is in the engaged position.

4. The apparatus of claim 1, further including a gearbox coupled between the output shaft of the electric motor and the fluid torque converter.

5. The apparatus of claim 1, further including a gearbox coupled between fluid torque converter and the drive shaft.

6. The apparatus of claim 1, wherein the fluid torque converter is a hydraulic torque converter.

7. The apparatus of claim 1, wherein the fluid torque converter includes a turbine and an impeller, wherein the impeller is coupled to the output shaft of the electric motor and the turbine is coupled to the drive shaft.

8. The apparatus of claim 7, wherein the clutch is slidably coupled to the turbine.

9. The apparatus of claim 8, further including a valve fluidly coupled to the clutch, the valve movable between a first position and a second position;
in the first position, the valve to cause the clutch to move to the engaged position to mechanically couple the output shaft of the electric motor and the drive shaft; and
in the second position, the valve to cause the clutch to move to the disengaged position to fluidly couple the output shaft of the electric motor and the drive shaft.

10. The apparatus of claim 9, further including a controller to cause the valve to move to the second position in response to detecting a rotor lock condition of the vehicle and determining that a vehicle speed does not exceed a vehicle speed threshold.

11. The apparatus of claim 9, further including a controller to cause the valve to move to the second position and operate the electric motor at least at a minimum motor speed threshold in response to detecting a rotor lock condition.

12. The apparatus of claim 10, wherein the rotor lock condition of the vehicle includes at least one of a towing mode, an off-road mode, an electric motor stall, an elevated grade, or an inverter condition.

13.-20. (canceled)

21. An apparatus comprising:
an electric motor having an output shaft;
a drive shaft operatively coupled to a wheel of a vehicle;
a fluid coupling interposed between the output shaft and the drive shaft, the fluid coupling to couple the output shaft of the electric motor and the drive shaft, the fluid coupling having a lock-out clutch movable between an engaged position and a disengaged position, the fluid coupling mechanically coupling the output shaft of the electric motor and the drive shaft when the lock-out clutch is in the engaged position, and the fluid coupling fluidly coupling the output shaft and the drive shaft to permit slip between the output shaft and drive shaft when the lock-out clutch is in a disengaged position.

22. The apparatus of claim 21, further including a control unit that, based on a sensed vehicle speed and a motor torque command, actuates the lock-out clutch to maintain a motor speed above a predetermined motor-speed threshold to prevent rotor lock of the electric motor.

23. An apparatus comprising:
an electric motor having an output shaft;
a drive shaft operatively coupled to a wheel of a vehicle;
a fluid coupling including a turbine, an impeller and a stator;
a lock-out clutch slidably coupled to the turbine of the fluid coupling; and
a controller operably connected to the lock-out clutch, the controller to actuate the lock-out clutch between an engaged position in which the fluid coupling mechanically couples the output shaft of the electric motor and the drive shaft, and a disengaged position in which the fluid coupling fluidly couples the output shaft and the drive shaft to permit slip.

24. The apparatus of claim 23, further including a gearbox coupled between the electric motor and the fluid coupling.

25. The apparatus of claim 23, wherein the fluid coupling is a hydraulic torque converter.

26. The apparatus of claim 23, wherein the impeller is coupled to the output shaft of the electric motor and the turbine is coupled to the drive shaft.

27. The apparatus of claim 26, wherein the lock-out clutch is slidably coupled to the turbine.

28. The apparatus of claim 23, further including a controller that, in response to detecting a rotor-lock condition when a vehicle speed is below a predetermined vehicle-speed threshold, causes the lock-out clutch to move to the disengaged position, and wherein the controller causes the lock-out clutch to remain in the disengaged position and maintains the electric motor speed above a predetermined minimum-motor-speed threshold while the rotor-lock condition persists.
